(19) United States
(12) Patent Application Publication
(10) Pub. No.: US 2004/0163310 A1
(43) Pub. Date: Aug. 26, 2004

(54) Method of propagating bananas

(76) Inventor: Shimon Tsurgil, Kibutz Hahortim (IL)

Correspondence Address: DARBY & DARBY P.C., P. O. BOX 5257, NEW YORK, NY, 10150-5257, US

(21) Appl. No.: 10/733,357

(22) Filed: Dec. 10, 2003

Related U.S. Application Data
(60) Provisional application No. 60/431,982, filed on Dec. 10, 2002.

(51) Int. Cl. A01G 1/00

(52) U.S. Cl. 47/58.1 FV

(57) ABSTRACT

The present invention relates to a method of propagating and cultivating species of the genus Musa (and in particular bananas) by planting a whole defoliated sucker of this species substantially horizontally in the ground.

This application claims the benefit of U.S. Provisional Application No. 60/431,982, filed Dec. 10, 2002, which is hereby incorporated by reference.

### FIELD OF THE INVENTION

The present invention relates to a method of propagating and cultivating species of the genus Musa (and in particular bananas) by planting a whole sucker (preferably defoliated) of this species substantially horizontally in the ground, such as in furrows.

### BACKGROUND OF THE INVENTION

Edible bananas are derived from a number of species in the genus Musa and are mainly grown in humid tropical regions. They constitute the fourth largest fruit crop in the world. Bananas are harvested from banana plants which are large perennial, herbaceous parthenocarpic monocotyledons. A mature banana plant is shown in FIG. 1. A banana plant includes a corm and a pseudostem which arises from it. The corm, also called a rhizome or plantling, lies almost entirely beneath the ground and is the true stem of the plant. In addition to the pseudostem, the corm produces several lateral vegetative offshoots, called suckers, which form a clump stool at the base of the plant. One sucker replaces the main plant after the plant produces fruit and dies.

Banana plants are propagated by a variety of methods, including, vegetative propagation from suckers or corms and propagation from tissue. Vegetative propagation and tissue culture propagation are the principle means of propagating bananas.

Propagation of bananas with suckers involves selecting an appropriate sucker from an existing banana “mother” plant and removing the sucker from the “mother” plant while leaving a portion of the corm attached. Once removed from the “mother” plant, each sucker consists of a corm having a cut end and a pseudostem which forms the follower end. Prior to the present invention, suckers were individually planted vertically in holes which are typically at least 30 cm wide and at least 35 cm deep. The sucker is orientated such that the cut corm end contacts the bottom of the hole and the majority of the pseudostem protrudes upward from the ground surface. The hole is then filled with soil, and the sucker is allowed to mature into an adult banana plant. A sucker planted by this technique is shown in FIG. 2. As a result of the vertical orientation of the sucker, the terminal growth apex, residing in the center of the pseudostem and atop the corm, experiences growth-retarding factors such as low temperature and pressure from the shrinking pseudostem as a result of temporary desiccation.

Propagation of banana plants by prior art process, however, is time consuming and expensive. It requires individual digging of holes and patting of soil. The plantlings which are typically purchased from meristem factories are expensive. Furthermore, each plantling only yields a single plant. Therefore, an improved method of propagating banana plants is needed.

### SUMMARY OF THE INVENTION

The inventor has surprisingly discovered that planting whole suckers (preferably defoliated), substantially horizontally dramatically improves yield and speeds growth while decreasing the cost of planting. Since whole defoliated suckers are unused byproducts from old plantations (i.e., picked banana plants), they may be obtained cheaply, sometimes for free.

Without being bound by any particular theory, the inventor theorizes that the lateral apexes of a sucker planted horizontally are nourished more effectively from the sucker's biomass than the vertical apex of a sucker planted vertically. The inventor also theorizes (without being bound by any particular theory) that banana plants grown according to the present invention grow faster because, the lateral apexes warm more quickly then the terminal apex of a sucker planted vertically.

The method of the present invention includes the steps of planting a whole sucker (preferably a whole defoliated sucker), sustantially horizontally in the ground and growing one or more plants therefrom (preferably two plants). Unlike the traditional technique of planting suckers vertically, the present method does not require the preparation of individual holes, which require significant manual labor. Rather, furrows (such as those that can be produced by farm machinery) can be formed in the ground and the suckers laid therein. Soil may then be placed over the corm of the suckers. Preferably, the soil forms a thin film over the corm, while the pseudostem remains exposed to the air. According to one preferred embodiment, the suckers are planted pairwise, preferably in a line with the corms of each sucker adjacent to one another (e.g., a line of suckers arranged F-C C-F F-C C-F, etc. where C and F represent the cut end (corm end) and follower end (pseudostem end) of the sucker, respectively).

Several warm offshoots (or vertical apexes) grow vertically out of each sucker, rather than a single banana plant as from a vertically planted sucker. One or more of the vertical offshoots, are selected for further growth (typically prior to maturity of the plant) and the remaining vertical offshoots are removed, for example, by destruction or pruning. Preferably, two of the vertical offshoots are selected to grow while the remaining lateral apexes are pruned or destroyed. As a result, two banana plants are grown from each sucker yielding about two bunches per laid sucker. Additionally, it has surprisingly been found that the two banana plants grow significantly faster than banana plants grown from vertically planted suckers.

According to one preferred embodiment, the method includes:

1. Obtaining whole defoliated suckers (which include the corm and pseudostem of the sucker);

2. Preparing a field by drawing furrows (e.g., furrows about 30 cm deep) such as with a tractor;

3. Optionally, marking the sites to lay down the whole defoliated suckers;

4. Inserting the whole defoliated suckers substantially horizontally pairwise into the furrows, so that the suckers are in a line and the corm of each sucker in a pair is adjacent the corm of the other sucker;

5. Covering only the corms while leaving the pseudostems exposed (i.e., exposed to the sun and the air);

6. Cultivating the corm and pseudostems of the planted suckers to form a plurality of vertical offshoots;

7. Removing (e.g., pruning or destroying) all but 1, 2, 3, or 4 (preferably all but two) of the vertical offshoots before any one of the apexes becomes a mature banana plant;

8. Cultivating the remaining vertical offshoots to maturity.

9. Optionally, cultivating fruit on the plant; and

10. Optionally, picking the fruit.

In yet another embodiment, there is provided a method of cultivating bananas comprising the steps of planting a whole defoliated sucker substantially horizontally, selecting at least two emerging suckers for further growth and removing (e.g. destroying or pruning) the remaining emerging suckers, maturing the selected suckers into adult banana plants, and cultivating the bananas produced by the adult plant.

### BRIEF DESCRIPTION OF THE DRAWINGS

FIG. 1 depicts a mature banana plant.

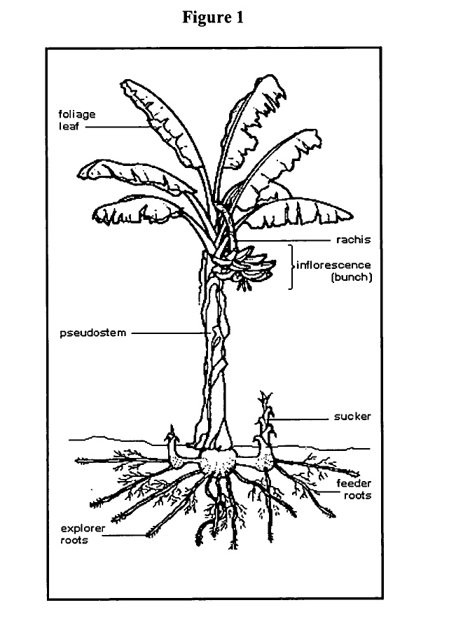

FIG. 2 depicts a sucker planted vertically by the traditional method.

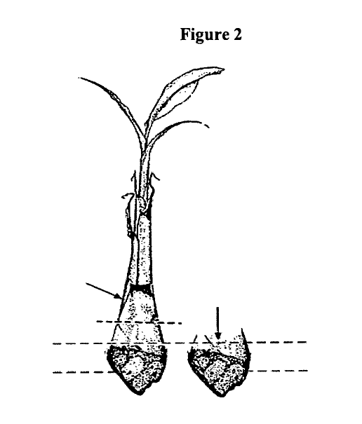

FIG. 3 is a photograph showing suckers inserted substantially horizontally in a furrow.

### DETAILED DESCRIPTION OF THE INVENTION

The term “bananas” as used herein refers to any species of the genus Musa, of the family Musaceae.

The term “propagation” as used herein refers to the production of one or more plants from a single plant source.

The phrase “planting the sucker substantially horizontally” refers to inserting or placing the sucker so that its longitudinal axis is substantially parallel to the ground, i.e., both the corm and the pseudostem are about the same depth, typically relatively shallow, in the ground.

The term “sucker” generally refers to lateral vegetative shoots which grow out of the corm and which are capable of producing an adult plant. Any whole sucker (preferably defoliated) of the genus Musa may be used. For example, the sucker may be from a mature banana plant. Preferably, the corm of the sucker selected for propagation has sufficiently matured and the sucker has not developed more then two wide leaves. The term “wide leaf” refers to a leaf having a width of at least about 25 cm.

The terms “vertical apexes” or “vertical offshoot” as used herein refer to vegetative growths which emerge substantially vertically from a sucker that has been planted substantially horizontally.

The present invention results in banana plants having higher fruit yields and decreased maturation times, as compared to banana plants propagated from suckers planted vertically. Additionally, the present invention provides for the propagation of more then one plant from each sucker, whereas suckers planted vertically yield only a single plant. Propagation of bananas according to the present invention also results in decreased labor costs as the suckers may be planted substantially horizontally in furrows, drawn mechanically, rather then in single hand dug holes.

Once a sucker is selected, it is removed from the corm of the main plant. Preferably the sucker is defoliated after it is removed from the main plant and prior to planting.

The selected sucker is planted substantially horizontally. While the sucker may be planted in any hole in the ground, a furrow is preferably formed in the ground, such as by a tractor, and the sucker is inserted therein, e.g., laid. The depth of the furrow is preferably from about 20 to about 35 cm and more preferably from about 25 to about 30 cm. Preferably, the sucker is oriented substantially parallel to the longitudinal axis of the furrow. Once the sucker is positioned in the furrow, the corm of the sucker is covered over with soil, preferably a thin film of soil. The pseudostem is preferably left exposed to the sun and air.

According to a preferred embodiment, the suckers are planted during the springtime, in a humid environment.

The sucker is cultivated and allowed to develop several vertical offshoots (or vertical apexes). Before maturity, one or more of the vertical offshoots is selected for cultivation. The remaining vertical offshoots are removed. The vertical offshoots which are not selected to be cultivated may be removed by any method known in the art including, but not limited to, manual removal or mechanical removal or chemical removal using such agents such kerosene. Preferably 1, 2, 3, or 4 vertical offshoots are selected. More preferably, only two vertical offshoots are selected for cultivation. The selected vertical offshoots are cultivated to maturity.

The plants may be cultivated by methods known in the art. For example, the planted sucker may be provided with nutrients, such as fertilizers, and given water. The planted sucker is maintained such that one or more, and preferably two, pseudostems mature into adult plants and at least one of the mature plants produces fruit. During cultivation of the selected vertical offshoots, unwanted competing offshoots are removed (e.g. pruned or destroyed).

The following example illustrates the present invention without limitation.

### EXAMPLE 1

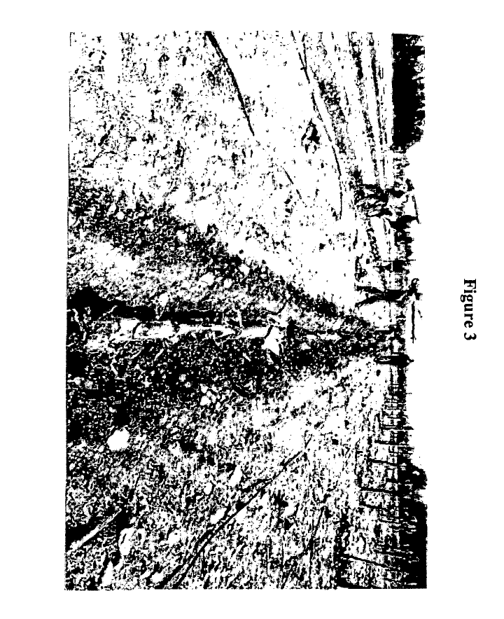

Furrows about 25 cm deep and 50 cm wide in a field were prepared with a tractor. Whole defoliated suckers were inserted substantially horizontally, pairwise, and in a line in the furrows. The suckers were oriented so that the corms of the suckers in each pair were adjacent one another. Each sucker was oriented substantially parallel to the longitudinal axis of the furrow, as shown in FIG. 3. The corm of each sucker was loosely covered with soil while the pseudostem of each sucker was left exposed. The suckers were cultivated to yield several vertical offshoots (or vertical apexes). Two vertical offshoots from each sucker were selected for further cultivation. The remaining vertical offshoots were removed by cutting or destroyed by kerosene. The selected vertical offshoots from each sucker were cultivated to maturity. Finally, the bananas formed on the mature vertical offshoots were picked.

The vertical offshoots (or vertical apexes) of the suckers planted substantially horizontally quickly developed into two or more young short shoots per sucker. The vertical offshoots from the suckers planted substantially horizontally similar to a normal banana plant and rotated quickly to acquire vertical posture. The vertical offshoots continued to mature and created, with their low dense foliage, a good shield against the overheating of the soil during the plantations first summer.

### COMPARATIVE EXAMPLE

Bananas were produced by the traditional method of planting a sucker vertically in a whole dug manually. The suckers which were planted vertically in holes suffered more from soil overheating, then suckers planted substantially horizontally in Example 1. The vertically planted suckers overheated, because they matured more slowly, displaying few leaves with long nodes between them and exposed the corm to the intense heat of the sun.

A comparison of the rate of flowering and the yields from the plants grown in Example 1 and the Comparative Example, are summarized in Tables 1 and 2 below. Banana plants propagated according to the present invention produced nearly twice as many flowers per unit area then banana plants propagated from suckers planted vertically (Table 1). Banana plants propagated according to the present invention also produced more bunches of fruit per unit area and yielded more fruit per unit area than plants propagated from suckers planted vertically (Table 2).

TABLE 1
Total number of flowers per dunam

| | | | | Flowers per | |
|---|---|---|---|---|---|
| | | Flowers per | Flowers per | dunam | Flowers per |
| Method of | Plantings | dunam | dunam | (November and | dunam (Total |
| Propagation | per dunam | (September) | (October) | December) | for Year) |
| Sucker Planted | 67 | 29 | 115 | 12 | 156 |
| Substantially | | | | | |
| Horizontally | | | | | |
| Sucker Planted | 82 | 48 | 32 | 8 | 88 |
| Vertically (Plot | | | | | |
| 6) | | | | | |
| Sucker Planted | 82 | 44 | 22 | 6 | 72 |
| Vertically (Plot | | | | | |
| 7) | | | | | |

TABLE 2
Comparison of banana yields from plants propagated from
suckers planted substantially horizontally and vertically.

| | | | | Average | |
|---|---|---|---|---|---|
| Method of | Plantings per | Bunches per | % Bunches | Weight (kg) | Yield (kg) |
| Propagation | dunam | dunam | per Planting | per bunch | per dunam |
| Sucker Planted | 80.9 | 142 | 177.4 | 22.0 | 3136.8 |
| Substantially | | | | | |
| Horizontally | | | | | |
| Sucker Planted | 66.1 | 67.1 | 101.5 | 23.9 | 1601.0 |
| Vertically (Plot 1) | | | | | |
| Sucker Planted | 57.0 | 78.9 | 138.4 | 23.0 | 1818.7 |
| Vertically (Plot 2) | | | | | |
| Sucker Planted | 80.4 | 91.3 | 111.3 | 23.0 | 2099.7 |
| Vertically (Plot 3) | | | | | |
| Sucker Planted | 63.4 | 74.6 | 111.9 | 23.6 | 1760.0 |
| Vertically (Plot 4) | | | | | |
| Sucker Planted | 64.5 | 79.8 | 123.7 | 23.8 | 1899.6 |
| Vertically (Plot 5) | | | | | |

All patents, applications, articles, statutes, and publications mentioned above are hereby incorporated by reference.

Many variations of the present invention will suggest themselves to those skilled in the art in light of the above detailed description. Such obvious variations are within the full intended scope of the appended claims.

What is claimed is:

1. A method of propagating a species of the genus Musa, comprising the step of:
(a) planting one or more whole defoliated suckers of the genus Musa substantially horizontally; and
(b) growing one or more plants from each sucker.

2. The method of claim 1, wherein step (a) comprises:
(i) providing a furrow in the ground;
(ii) inserting each whole defoliated sucker substantially horizontally into the furrow; and
(iii) covering the corm of each sucker with soil while leaving the pseudostem exposed.

3. The method of claim 2, wherein each whole defoliated sucker is oriented in the furrow so that its longitudinal axis is parallel to that of the furrow.

4. The method of claim 3, wherein the whole defoliated suckers are planted pairwise.

5. The method of claim 4, wherein the corms of the whole defoliated suckers in each pair are adjacent one another.

6. The method of claim 1, wherein step (b) comprises:
(i) cultivating the whole defoliated sucker to yield a plurality of vertical offshoots;
(ii) selecting a plurality of vertical offshoots to cultivate and removing the remaining vertical offshoots;
(iii) cultivating the selected vertical offshoots to maturity.

7. The method of claim 6, wherein only two vertical offshoots are selected in step (b)(ii).

8. The method of 7, wherein the vertical offshoots are removed by pruning or destruction.

9. The method of claim 1, further comprising the step of (c) cultivating fruit from the plants.

10. The method of claim 9, further comprising the step of (d) picking the fruit.

11. The method of claim 10, wherein the fruit is banana.

12. In a method of propagating bananas from suckers, the improvement comprising planting whole defoliated suckers substantially horizontally.

13. Bananas prepared by the method of claim 1.
